(19) United States
(12) Patent Application Publication
(10) Pub. No.: US 2025/0299090 A1
(43) Pub. Date: Sep. 25, 2025

(54) TRAINING MACHINE LEARNING TRANSFORMER ARCHITECTURES WITH HYBRID MOVING AVERAGE

(71) Applicant: Databricks, Inc., San Francisco, CA (US)

(72) Inventors: Austin Joshua Jacobson, Sunnyvale, CA (US); Mihir Vipul Patel, New York City, NY (US); Landan Joseph Seguin, San Francisco, CA (US); Cory Ryan Stephenson, Mountain View, CA (US)

(21) Appl. No.: 18/610,072

(22) Filed: Mar. 19, 2024

(51) Int. Cl. G06N 20/00

(52) U.S. Cl. CPC G06N 20/00

(57) ABSTRACT

A data processing service trains a transformer model in two stages. In a first stage, for a first number of iterations, the data processing service trains the model without computing moving average parameters. In a second stage, for a second number of iterations, the data processing service trains the model using parameters that follow a moving average of the training parameters. In the second stage, the data processing service obtains moving average parameters for a current iteration and generates training parameters for the current iteration. The data processing service computes moving average parameters for a next iteration by combining the training parameters for the current iteration and the moving average parameters for the current iteration. The data processing service updates the moving average parameters for the next iteration as the moving average parameters for the current iteration.

### TECHNICAL FIELD

The disclosed configuration relates generally to training transformer models, and more particularly to training transformer models using exponential moving average techniques.

### BACKGROUND

Often times, transformer-based architectures, such as stable diffusion (text-to-image generation) models, are trained using a moving average technique. However, training a transformer model using moving average techniques may require maintaining a copy of both the model's training parameters and the model's averaged parameters. Thus, training a model using moving average techniques requires more on-device memory. For example, a device might require extra memory equal to the size of the model's training parameters and buffers. Additionally, training models using moving average techniques often requires more compute to calculate the moving average at each iteration.

### BRIEF DESCRIPTION OF THE DRAWINGS

The disclosed embodiments have other advantages and features which will be more readily apparent from the detailed description, the appended claims, and the accompanying figures (or drawings). A brief introduction of the figures is below.

FIG. 1 is a high-level block diagram of a system environment for a data processing service, in accordance with an embodiment.

FIG. 2 illustrates a block diagram of an architecture of a data storage system, in accordance with an embodiment.

FIG. 3 illustrates a block diagram of an architecture of a control layer, in accordance with an embodiment.

FIG. 4 illustrates a block diagram of an architecture of a cluster computing system of the data layer, in accordance with an embodiment.

FIG. 5 is a block diagram of an architecture of a driver node, in accordance with an embodiment.

FIG. 6 is a block diagram illustrating a process for generating exponential moving average parameters, in accordance with an embodiment.

FIG. 7 illustrates a method for training a transformer model, in accordance with an embodiment.

FIG. 8 illustrates an example machine to read and execute computer readable instructions, in accordance with an embodiment.

### DETAILED DESCRIPTION

The figures depict various embodiments of the present configuration for purposes of illustration only. One skilled in the art will readily recognize from the following discussion that alternative embodiments of the structures and methods illustrated herein may be employed without departing from the principles of the configuration described herein.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

A data processing service trains a transformer model in two stages. In a first stage, for a first number of iterations, the data processing service trains the model without computing moving average parameters. In a second stage, for a second number of iterations, the data processing service trains the transformer model using moving average parameters. The data processing service thus avoids the extra costs (both memory and computational) associated with moving average techniques for the first stage of training. Notably, this method removes the need for the data processing service to read and write both moving average parameters and parameters computed in training (e.g., with gradient descent) to a cache or data storage.

Additionally, the data processing service selects the first and second number of iterations such that the training parameters computed in the first stage contribute to the final parameters used for inference by less than a threshold percentage (e.g., 1%). This ensures that the model trained in two stages achieves similar performance to a model trained with moving average parameters for all training iterations, while reducing heavy and high-latency read and write operations at every step of training.

The data processing service may train transformer models, diffusion models (e.g., a stable diffusion model), or any other neural network model.

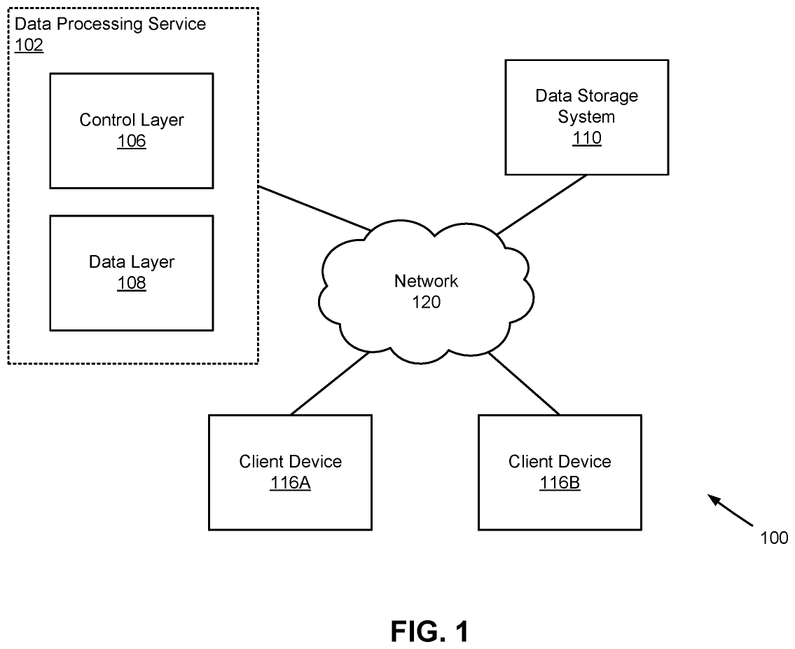

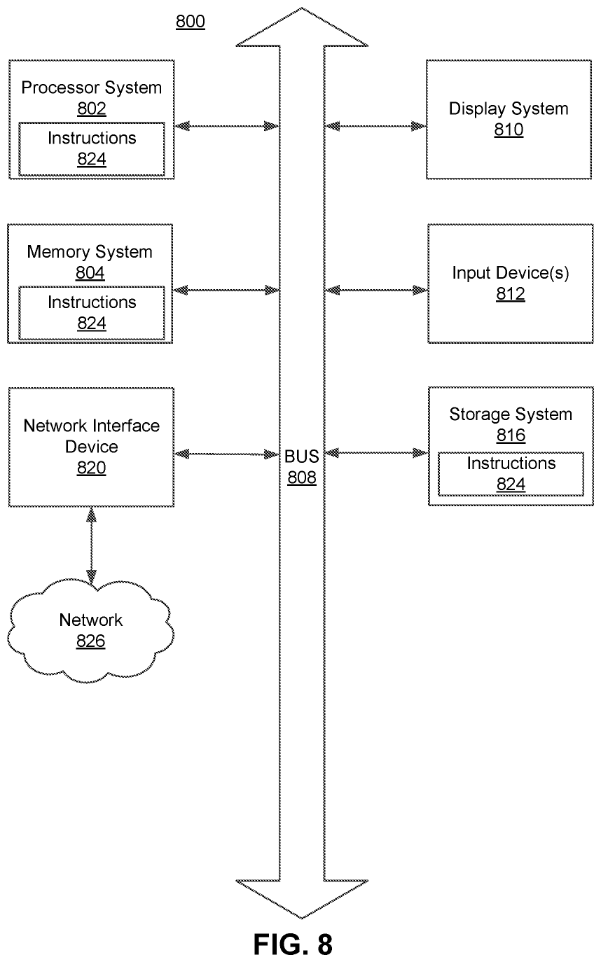

Figure (FIG. 1 is a high-level block diagram of a system environment 100 for a data processing service 102, in accordance with an embodiment. The system environment 100 shown by FIG. 1 includes one or more client devices 116A, 116B, a network 120, a data processing service 102, and a data storage system 110. In alternative configurations, different and/or additional components may be included in the system environment 100. The computing systems of the system environment 100 may include some or all of the components (systems (or subsystems)) of a computer system 800 as described with FIG. 8.

The data processing service 102 is a service for managing and coordinating data processing services (e.g., database services) to users of client devices 116. The data processing service 102 may manage one or more applications that users of client devices 116 can use to communicate with the data processing service 102. Through an application of the data processing service 102, the data processing service 102 may receive requests (e.g., database queries) from users of client devices 116 to perform one or more data processing functionalities on data stored, for example, in the data storage system 110. The requests may include query requests, analytics requests, or machine learning and artificial intelligence requests, and the like, on data stored by the data storage system 110. The data processing service 102 may provide responses to the requests to the users of the client devices 116 after they have been processed.

In one embodiment, as shown in the system environment 100 of FIG. 1, the data processing service 102 includes a control layer 106 and a data layer 108. The components of the data processing service 102 may be configured by one or more servers and/or a cloud infrastructure platform. In one embodiment, the control layer 106 receives data processing requests and coordinates with the data layer 108 to process the requests from client devices 116. The control layer 106 may schedule one or more jobs for a request or receive requests to execute one or more jobs from the user directly through a respective client device 116. The control layer 106 may distribute the jobs to components of the data layer 108 where the jobs are executed.

The control layer 106 is additionally capable of configuring the clusters in the data layer 108 that are used for executing the jobs. For example, a user of a client device 116 may submit a request to the control layer 106 to perform one or more queries and may specify that four clusters on the data layer 108 be activated to process the request with certain memory requirements. Responsive to receiving this information, the control layer 106 may send instructions to the data layer 108 to activate the requested number of clusters and configure the clusters according to the requested memory requirements.

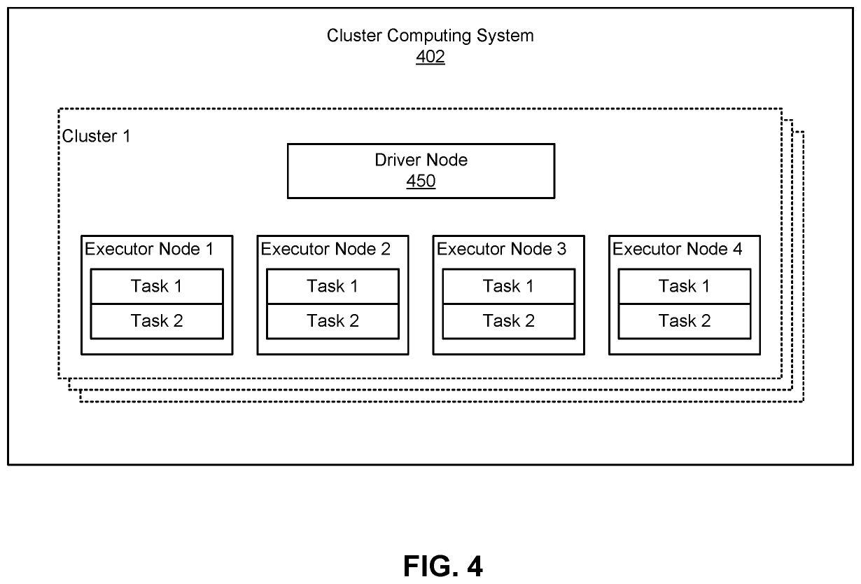

The data layer 108 includes multiple instances of clusters of computing resources that execute one or more jobs received from the control layer 106. Accordingly, the data layer 108 may include a cluster computing system for executing the jobs. An example of a cluster computing system is described in relation to FIG. 4. In one instance, the clusters of computing resources are virtual machines or virtual data centers configured on a cloud infrastructure platform. In one instance, the control layer 106 is configured as a multi-tenant system and the data layers 108 of different tenants are isolated from each other. In one instance, a serverless implementation of the data layer 108 may be configured as a multi-tenant system with strong virtual machine (VM) level tenant isolation between the different tenants of the data processing service 102. Each customer represents a tenant of a multi-tenant system and shares software applications and also resources such as databases of the multi-tenant system. Each tenant's data is isolated and remains invisible to other tenants. For example, a respective data layer instance can be implemented for a respective tenant. However, it is appreciated that in other embodiments, single tenant architectures may be used.

The data layer 108 thus may be accessed by, for example, a developer through an application of the control layer 106 to execute code developed by the developer. In one embodiment, a cluster in a data layer 108 may include multiple worker nodes that execute multiple jobs in parallel. Responsive to receiving a request, the data layer 108 divides the cluster computing job into a set of worker jobs, provides each of the worker jobs to a worker node, receives worker job results, stores job results, and the like. The data layer 108 may include resources not available to a developer on a local development system, such as powerful computing resources to process very large data sets. In this manner, when the data processing request can be divided into jobs that can be executed in parallel, the data processing request can be processed and handled more efficiently with shorter response and processing time.

In one embodiment, the data processing service 102 trains different types of machine-learned transformer architectures. The transformer architectures may include large language models (LLM's), text-to-image models (e.g., stable diffusion models), and the like. The architecture may be an encoder-decoder architecture, or architectures with only a set of decoders or only a set of encoders. In one embodiment, the data processing service 102 trains machine-learned models using a moving average approach.

One example of using moving averages is an exponential moving average (EMA) technique. EMA is a model averaging technique where the data processing service 102 maintains an exponential moving average of the parameters through one or more training iterations. In using EMA, the parameters are based on two sets of parameters-a first set of moving average parameters and a second set of parameters. The first set is a previous state of the parameters, while the second set is a new set of parameters for a current iteration that incorporates backpropagation techniques based on a loss function for that iteration. Therefore, for a given iteration, both sets of parameters may be stored and used for the training process. Without using EMA, the final parameters used for inference are generated based just on the parameters updated through backpropagation. Models trained using EMA typically have better generalization and less overfitting than models trained without EMA.

However, as described above, moving average techniques require extra computational resources (both memory and computational) to store an extra set of parameters (i.e., moving average parameters) in addition to the parameters that are updated via backpropagation. Therefore, as described in further detail below, the data processing service 102 trains machine-learned transformer architectures in two stages, where for a first number of iterations, the moving average technique is not performed, and for a second number of iterations, the moving average technique is performed. This way, the data processing service 102 avoids the extra resources (both memory and/or computational) associated with moving average techniques for the first stage of training. Notably, this method removes the need for the data processing service 102 to read and write both moving average parameters and parameters computed in training (e.g., with gradient descent) to a cache or data storage for the first stage.

The data storage system 110 includes a device (e.g., a disc drive, a hard drive, a semiconductor memory) used for storing database data (e.g., a stored data set, portion of a stored data set, data for executing a query). In one embodiment, the data storage system 110 includes a distributed storage system for storing data and may include a commercially provided distributed storage system service. Thus, the data storage system 110 may be managed by a separate entity than an entity that manages the data processing service 102 or the data management system 110 may be managed by the same entity that manages the data processing service 102.

The client devices 116 are computing devices that display information to users and communicates user actions to the systems of the system environment 100. While two client devices 116A, 116B are illustrated in FIG. 1, in practice many client devices 116 may communicate with the systems of the system environment 100. In one embodiment, client devices 116 of the system environment 100 may include some or all of the components (systems (or subsystems)) of a computer system 800 as described with FIG. 8.

In one embodiment, a client device 116 executes an application allowing a user of the client device 116 to interact with the various systems of the system environment 100 of FIG. 1. For example, a client device 116 can execute a browser application to enable interaction between the client device 116 and the data processing system 106 via the network 120. In another embodiment, the client device 116 interacts with the various systems of the system environment 100 through an application programming interface (API) running on a native operating system of the client device 116, such as IOS® or ANDROID™.

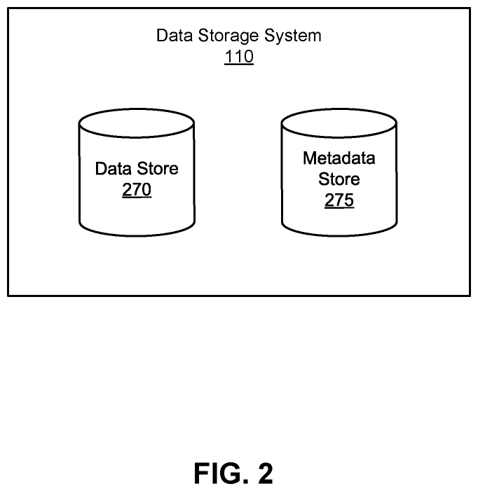

FIG. 2 is a block diagram of an architecture of a data storage system 108, in accordance with an embodiment. The data storage system 108 includes a data tables store 270 and a metadata store 275.

The data store 270 stores data associated with different tenants of the data processing service 102. In one embodiment, the data in data store 270 is stored in a format of a data table. A data table may include a plurality of records or instances, where each record may include values for one or more features. The records may span across multiple rows of the data table and the features may span across multiple columns of the data table. In other embodiments, the records may span across multiple columns and the features may span across multiple rows. For example, a data table associated with a security company may include a plurality of records each corresponding to a login instance of a respective user to a website, where each record includes values for a set of features including user login account, timestamp of attempted login, whether the login was successful, and the like. In one embodiment, the plurality of records of a data table may span across one or more data files. For example, a first subset of records for a data table may be included in a first data file and a second subset of records for the same data table may be included in another second data file.

In one embodiment, a data table may be stored in the data store 270 in conjunction with metadata stored in the metadata store 275. In one instance, the metadata includes transaction logs for data tables. Specifically, a transaction log for a respective data table is a log recording a sequence of transactions that were performed on the data table. A transaction may perform one or more changes to the data table that may include removal, modification, and additions of records and features to the data table, and the like. For example, a transaction may be initiated responsive to a request from a user of the client device 116. As another example, a transaction may be initiated according to policies of the data processing service 102. Thus, a transaction may write one or more changes to data tables stored in the data storage system 110.

In one embodiment, a new version of the data table is committed when changes of a respective transaction are successfully applied to the data table of the data storage system 108. Since a transaction may remove, modify, or add data files to the data table, a particular version of the data table in the transaction log may be defined with respect to the set of data files for the data table. For example, a first transaction may have created a first version of a data table defined by data files A and B each having information for a respective subset of records. A second transaction may have then created a second version of the data table defined by data files A, B and in addition, new data file C that include another respective subset of records (e.g., new records) of the data table.

In one embodiment, the transaction log may record each version of the table, the data files associated with a respective version of the data table, information pertaining to the type of transactions that were performed on the data table, the order in which the transactions were performed (e.g., transaction sequence number, a timestamp of the transaction), and an indication of data files that were subject to the transaction, and the like. In some embodiments, the transaction log may include change data for a transaction that also records the changes for data written into a data table with respect to the previous version of the data table. The change data may be at a relatively high level of granularity, and may indicate the specific changes to individual records with an indication of whether the record was inserted, deleted, or updated due to the corresponding transaction.

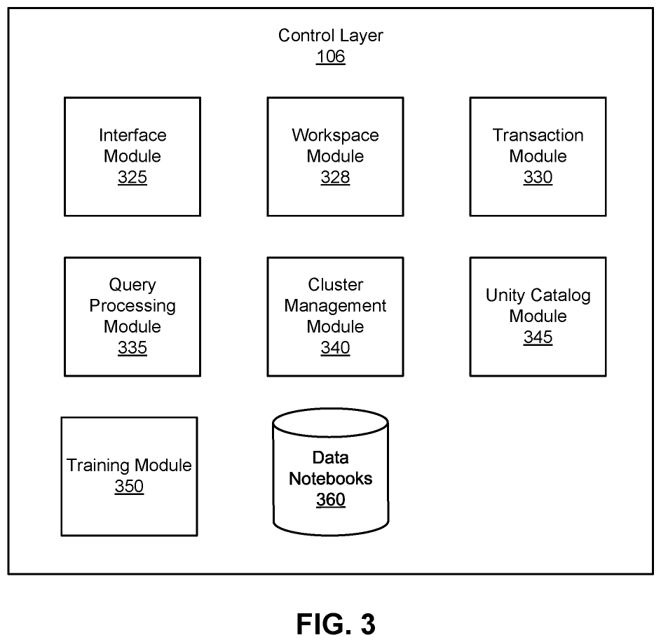

FIG. 3 is a block diagram of an architecture of a control layer 106, in accordance with an embodiment. In one embodiment, the control layer 106 includes an interface module 325, a transaction module 330, a query processing module 335, a cluster management module 340, and a training module 350. The control layer 106 also includes a data notebook store 360. The modules 325, 330, 335, 340, and 350 may be structured for execution by a computer system, e.g., 800 having some or all of the components as described in FIG. 8, such that the computer system 800 operates in a specified manner as per the described functionality.

The interface module 325 provides an interface and/or a workspace environment where users of client devices 116 (e.g., users associated with tenants) can access resources of the data processing service 102. For example, the user may retrieve information from data tables associated with a tenant, submit data processing requests such as query requests on the data tables, through the interface provided by the interface module 325. The interface provided by the interface module 325 may include notebooks, libraries, experiments, queries submitted by the user. In one embodiment, a user may access the workspace via a user interface (UI), a command line interface (CLI), or through an application programming interface (API) provided by the workspace module 325.

For example, a notebook associated with a workspace environment is a web-based interface to a document that includes runnable code, visualizations, and explanatory text. A user may submit data processing requests on data tables in the form of one or more notebook jobs. The user provides code for executing the one or more jobs and indications such as the desired time for execution, number of cluster worker nodes for the jobs, cluster configurations, a notebook version, input parameters, authentication information, output storage locations, or any other type of indications for executing the jobs. The user may also view or obtain results of executing the jobs via the workspace.

The workspace module 328 deploys workspaces within the data processing service 102. A workspace as defined herein may refer to a deployment in the cloud that functions as an environment for users of the workspace to access assets. An account of the data processing service 102 represents a single entity that can include multiple workspaces. In one embodiment, an account associated with the data processing service 102 may be associated with one workspace. In another embodiment, an account may be associated with multiple workspaces. A workspace organizes objects, such as notebooks, libraries, dashboards, and experiments into folders. A workspace also provides users access to data objects, such as tables or views or functions, and computational resources such as cluster computing systems.

In one embodiment, a user or a group of users may be assigned to work in a workspace. The users assigned to a workspace may have varying degrees of access permissions to assets of the workspace. For example, an administrator of the data processing service 102 may configure access permissions such that users assigned to a respective workspace are able to access all of the assets of the workspace. As another example, users associated with different subgroups may have different levels of access, for example users associated with a first subgroup may be granted access to all data objects while users associated with a second subgroup are granted access to only a select subset of data objects.

The transaction module 330 receives requests to perform one or more transaction operations from users of client devices 116. As described in conjunction in FIG. 2, a request to perform a transaction operation may represent one or more requested changes to a data table. For example, the transaction may be to insert new records into an existing data table, replace existing records in the data table, delete records in the data table. As another example, the transaction may be to rearrange or reorganize the records or the data files of a data table to, for example, improve the speed of operations, such as queries, on the data table. For example, when a particular version of a data table has a significant number of data files composing the data table, some operations may be relatively inefficient. Thus, a transaction operation may be a compaction operation that combines the records included in one or more data files into a single data file.

The query processing module 335 receives and processes queries that access data stored by the data storage system 110. The query processing module 335 may reside in the control layer 106. The queries processed by the query processing module 335 are referred to herein as database queries. The database queries are specified using a declarative database query language such as the SQL. The query processing module 335 compiles a database query specified using the declarative database query language to generate executable code that is executed. The query processing module 335 may encounter runtime errors during execution of a database query and returns information describing the runtime error including an origin of the runtime error representing a position of the runtime error in the database query. In one embodiment, the query processing module 335 provides one or more queries to appropriate clusters of the data layer 108, and receives responses to the queries from clusters in which the queries are executed.

The unity catalog module 345 is a fine-grained governance solution for managing assets within the data processing service 102. It helps simplify security and governance by providing a central place to administer and audit data access. In one embodiment, the unity catalog module 345 maintains a metastore for a respective account. A metastore is a top-level container of objects for the account. The metastore may store data objects and the permissions that govern access to the objects. A metastore for an account can be assigned to one or more workspaces associated with the account. In one embodiment, the unity catalog module 345 organizes data as a three-level namespace, a catalogue is the first layer, a schema (also called a database) is the second layer, and tables and views are the third layer.

In one embodiment, the unity catalog module 345 enables read and write of data to data stored in cloud storage of the data storage system 110 on behalf of users associated with an account and/or workspace. In one instance, the unity catalog module 345 manages storage credentials and external locations. A storage credential represents an authentication and authorization mechanism for accessing data stored on the data storage system 110. Each storage credential may be subject to access-control policies that control which users and groups can access the credential. An external location is an object that combines a cloud storage path (e.g., storage path in the data storage system 110) with a storage credential that authorizes access to the cloud storage path. Each storage location is subject to access-control policies that control which users and groups can access the storage credential. Therefore, if a user does not have access to a storage credential in the unity catalog module 345, the unity catalog module 345 does not attempt to authenticate to the data storage system 110.

In one embodiment, the unity catalog module 345 allows users to share assets of a workspace and/or account with users of other accounts and/or workspaces. For example, users of Company A can configure certain tables owned by Company A that are stored in the data storage system 110 to be shared with users of Company B. Each organization may be associated with separate accounts on the data processing service 102. Specifically, a provider entity can share access to one or more tables of the provider with one or more recipient entities.

Responsive to receiving a request from a provider to share one or more tables (or other data objects), the unity catalog module 345 creates a share in the metastore of the provider. A share is a securable object registered in the metastore for a provider. A share contains tables and notebook files from the provider metastore that the provider would like to share with a recipient. A recipient object is an object that associates an organization with a credential or secure sharing identifier allowing that organization to access one or more shares of the provider. In one embodiment, a provider can define multiple recipients for a given metastore. The unity catalog module 345 in turn may create a provider object in the metastore of the recipient that stores information on the provider and the tables that the provider has shared with the recipient. In this manner, a user associated with a provider entity can securely share tables of the provider entity that are stored in a dedicated cloud storage location in the data storage system 110 with users of a recipient entity by configuring shared access in the metastore.

The training module 350 trains one or more machine-learned models in conjunction with the cluster resources of the data processing service 102. In one embodiment, the training module 350 trains transformer models using moving average techniques. In some embodiments, the training module 350 may train a diffusion model, such as stable diffusion model. The training module 350 obtains a set of training examples, such as training examples uploaded to the data store 270 by a user. The training module 350 divides the training examples into one or more batches for one or more iterations of training. For example, the training module 350 may divide a data set into one million batches and train a transformer model over one million training iterations.

In some embodiments, the training module 350 trains a transformer model using a moving average technique, where the training module 350 generates moving average parameters that follow the moving average of the training parameters at each iteration of training. In alternative embodiments, the training module 350 trains the transformer model in two stages, training in a first stage without using moving average parameters and training in a second stage using moving average parameters.

In the first stage, the training module 350 trains the transformer model without calculating a moving average of parameters. Namely, for a first number of iterations, the training module 350 trains the transformer model based on a set of parameters for the current iteration (t) of training. For a batch of training examples for the current iteration, the training module 350 generates predictions by applying the set of parameters of the previous iteration to the batch of training examples for the current iteration. The training module 350 computes a loss function for the batch of training examples based on the predictions. The loss represents the difference between expected outputs of the transformer model and actual outputs of the transformer model. The training module 350 backpropagates error terms obtained from the loss function to update the set of parameters and to reduce the loss function. The training module 350 may use gradient descent to minimize the loss function. The training module 350 may store the set of parameters for the current iteration in a cache or in data store 270, such that it can be used during the next iteration of the training process.

In a second stage, for a second number of iterations, the training module 350 trains the transformer model using moving average parameters. That is, the training module 350 generates parameters for an iteration that follow the exponential moving average of the parameters in previous iterations. The generated parameters may be herein referred to as “moving average parameters.” In some embodiments, the training module 350 generates moving average parameters with the following equation,

$${W}_{e m a m o d e l}^{( t + 1 )} = smoothing \times {W}_{e m a m o d e l}^{( t )} + ( 1 - smoothing ) \times {W}_{m o d e l}^{( t )} \qquad EQ . 1$$

In Equation 1, the moving average parameters for the next iteration, W_{emamodel}^{(t+1)}, are generated by multiplying the moving average parameters of the current iteration, W_{emamodel}^{(t)}, by a smoothing constant and by multiplying the set of parameters, W_{model}^{(t)}, by a term of one minus the smoothing constant.

The moving average parameters of the current iteration, W(t)emamodel, follow the moving average of parameters in previous iterations. The training module 350 generates moving average parameters for the next iteration (e.g., using Equation 1) and stores the moving average parameters (e.g., in a cache or in data store 270), such that the stored moving average parameters are now used for the next iteration. For the following iterations in the second stage, the training module 350 obtains the moving average parameters for the current iteration from where they are stored.

To generate the set of parameters for the current iteration, W_{model}^{(t)}, the training module 350 performs a process like the process performed in the first stage. For a batch of training examples, the training module 350 applies the set of parameters of the previous iteration to the batch of training examples for the current iteration. The training module 350 computes a loss function for the batch of training examples based on the predictions. The training module 350 computes new training parameters for the current iteration to reduce the loss function. The training module 350 may use gradient descent to minimize the loss function. The training module 350 may store the set of parameters for the current iteration in a cache or in data store 270.

The training module 350 selects a smoothing constant. The smoothing constant represents the degree to which moving average parameters from previous iterations of training are used in the generation of moving average parameters for the current iteration of training. The smoothing constant is a value between zero and one (e.g., 0.9999). A higher smoothing constant means that parameters from a previous state contribute to more future iterations. The training module 350 may compute the smoothing constant based on a half-life. A half-life represents how many iterations it takes for the parameters of a given iteration to reduce from contributing fully to contributing 50%. The training module 350 may compute the smoothing constant using Equation 2,

$$smoothing = exp ( - \frac{log ( 2 )}{{t}_{\frac{1}{2}}} ) \qquad EQ . 2$$

In Equation 2, the half-life is shown as t_{1/2}. Using Equation 2, for a half-life of one, the smoothing constant would be 0.5. The training module 350 may select a half-life and compute the smoothing constant using Equation 2 or may select the smoothing constant and compute the half-life by solving EQ. 2 for t_{1/2}.

The training module 350 selects the number of iterations in the first stage and in the second stage based on a decay, the smoothing constant, and a total number of iterations. The decay (or degree of decay) represents the extent to which the training parameters computed in the first stage contribute to the final parameters used for inference (i.e., the moving average parameters computed at the last iteration at the end of the second stage). Given that the training module 350 multiplies the moving average parameters by a smoothing constant between zero and one at each iteration, the moving average parameters decay by a factor of the smoothing constant at every iteration. As such, the training module may compute the decay based on the following equation,

$$decay = {smoothing}^{{i}_{2}} \qquad EQ . 3$$

In Equation 3, i₂ represents the number of iterations in the second stage of training. To use an example, for a smoothing constant of 0.9999 and 50,000 iterations in the second stage, the parameters computed in the first stage would decay by a factor of 0.9999^{50,000}, or around 0.0067. This means that the parameters computed in the first stage contribute 0.67% to the parameters used for inference, if a moving average were to be performed. For a model with 1,400,000 training iterations, training with moving average parameters in the last 50,000 iterations achieves similar performance to training with moving average parameters in all iterations while avoiding the associated memory and computational costs associated with moving average techniques for 1,350,000 iterations, or almost 96.5% of training. Thus, the proposed method works well for situations where the number of training iterations is high, especially when compared to the half-life.

The training module 350 may set the decay to a value (e.g., 0.01, or 1%) and solve for the number of iterations in the second stage of training based on Equation 3. The training module 350 may solve for the number of iterations in the first stage such that the number of iterations in the first stage and the number of iterations in the second stage add up to the total number of iterations. For example, if there are 1,400,000 iterations of training, the training module 350 may select the first 1,350,000 iterations for the first stage and the last 50,000 iterations for the second stage.

In some embodiments, the training module 350 selects an update interval. An update interval is a period at which updates to the moving average are computed. A longer update interval means that updates are computed less frequently. For example, for an update interval of one batch, the training module 350 would compute moving average parameters for every batch. For an update interval of ten batches, the training module 350 would compute moving average parameters for every tenth batch.

In some embodiments, the transformer model architecture is configured as a text-to-image stable diffusion model including a convolutional U-net. The U-net denoiser model, at a given denoising iteration (different from training iteration), is configured to receive one or more inputs and generate one or more outputs. In one embodiment, the inputs are configured as latent representations that are 2-D or 3-D tensors when the generation task is for an image. The one or more inputs are images or videos, and the inputs may be three-dimensional tensors with a width (W), height (H), and channels (C). However, it is appreciated that in other embodiments, the inputs to the U-net denoiser model may include other types of data modalities such as text, audio, a combination of text and images, text and audio, video and text across various data modalities.

In such an embodiment, the training module 350 may use the method described herein for every parameter in the U-net or for only a subset of parameters in the U-net. For example, for the second number of training iterations, the training module 350 may perform moving average for a subset of parameters of the U-net but not perform moving average for parameters associated with attention layers of the U-net. For example, these parameters may be parameters for generating the query, key, value for one or more attention layers, or parameters that are multiplied to generate the attention outputs. Therefore, while a subset of parameters in the U-net are associated with a set of moving average parameters that are update based on the method described above, another subset of parameters in the U-net for the attention layers can be updated using backpropagation only for the second number of iterations.

FIG. 4 is a block diagram of an architecture of a cluster computing system 402 of the data layer 108, in accordance with an embodiment. In some embodiments, the cluster computing system 402 of the data layer 108 includes driver node 450 and worker pool including multiple executor nodes. The nodes may be structured for execution by a computer system, e.g., 800 having some or all of the components as described in FIG. 8, such that the computer system 800 operates in a specified manner as per the described functionality.

The driver node 450 receives one or more jobs for execution, divides a job into job stages, and provides job stages to executor nodes, receives job stage results from the executor nodes of the worker pool, and assembles job stage results into complete job results, and the like. In one embodiment, the driver node receives a request to execute one or more queries from the query processing module 335. The driver node 450 may compile a database query and generate an execution plan. The driver node 450 distributes the query information including the generated code to the executor nodes. The executor nodes execute the query based on the received information.

The worker pool can include any appropriate number of executor nodes (e.g., 4 executor nodes, 12 executor nodes, 256 executor nodes). Each executor node in the worker pool includes one or more execution engines (not shown) for executing one or more tasks of a job stage. In one embodiment, an execution engine performs single-threaded task execution in which a task is processed using a single thread of the CPU. The executor node distributes one or more tasks for a job stage to the one or more execution engines and provides the results of the execution to the driver node 410. According to an embodiment, an executor node executes the generated code for the database query for a particular subset of data that is processed by the database query. The executor nodes execute the query based on the received information from the driver node 450.

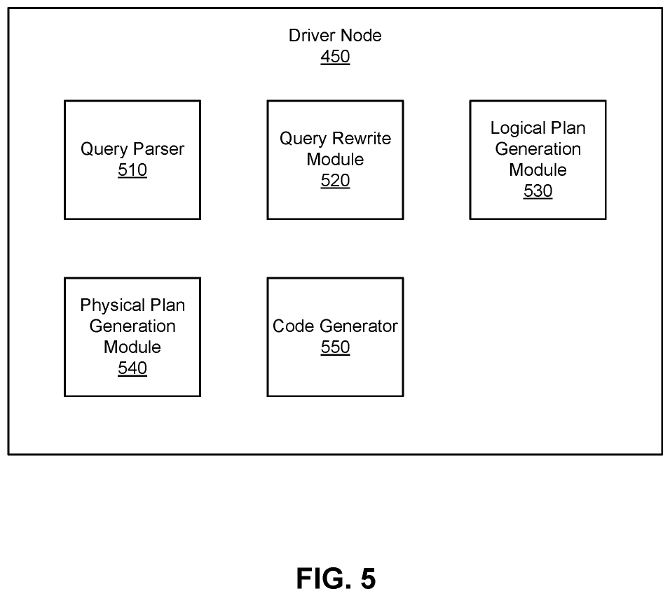

FIG. 5 is a block diagram of an architecture of a driver node 450, in accordance with an embodiment. In one instance, the driver node 450 includes a query parser 510, a query rewrite module 520, a logical plan generation module 530, and a physical plan generation module 540. The modules and nodes may be structured for execution by a computer system, e.g., 800 having some or all of the components as described in FIG. 8, such that the computer system 800 operates in a specified manner as per the described functionality.

The query parser 510 receives a database query for processing and parses the database query. The database query is specified using a declarative database query language such as SQL. The query parser 510 parses the database query to identify various tokens of the database query and build a data structure representation of the database query. The data structure representation identifies various components of the database query, for example, any SELECT expressions that are returned by the database query, tables that are input to the query, a conditional clause of the database query, a group by clause, and so on. According to an embodiment, the data structure representation of the database query is a graph model based on the database query.

The query rewrite module 520 performs transformations of the database query, for example, to improve the execution of the query. The improvement may be in terms of execution time, memory utilization, or other resource utilization. A database query may process one or more tables that store a significant number of records that are processed by the database query. Since the declarative database query language does not specify the procedure for determining the result of the database query, there are various possible procedures for executing the database query.

The query rewrite module 520 may transform the query to change the order of processing of certain steps, for example, by changing the order in which tables are joined, by changing the order in which certain operations such as filtering of records of a table is performed in relation to other operations. The query rewrite module 520 may transform the database query to cause certain temporary results to be materialized. The query rewrite module 520 may eliminate certain operations if the operations are determined to be redundant. The query rewrite module 520 may transform a database query so that certain computations such as subqueries or expressions are shared. The query rewrite module 520 may transform the database query to pushdown certain computations, for example, by changing the order in which certain predicates are applied to the computation as early as possible. The query rewrite module 520 may transform the database query to modify certain predicates to use more optimized versions of the predicates that are computationally equivalent but provide better performance.

The logical plan generation module 530 generates a logical plan for the database query. The logical plan includes representation of the various steps that need to be executed for processing the database query. According to an embodiment, the logical plan generation module 530 generates an unresolved logical plan based on the transformed query graph representation. Various relation names (or table names) and column names may not be resolved in an unresolved logical plan. The logical plan generation module 530 generates a resolved logical plan from the unresolved logical plan by resolving the relation names and column names in the unresolved logical plan. The logical plan generation module 530 further optimizes the resolved logical plan to obtain an optimized logical plan.

The physical plan generation module 540 generates a physical plan from the logical plan generated by the logical plan generation module 530. The physical plan specifies details of how the logical plan is executed by the data processing service 102. The physical plan generation module 540 may generate different physical plans for the same logical plan and evaluate each physical plan using a cost model to select the optimal physical plan for execution. The physical plan further specifies details of various operations of the logical plan. As an example, if the logical plan includes a join operator, the physical plan may specify the type of join that should be performed for implementing the join operator. For example, the physical plan may specify whether the join operator should be implemented as a hash join, merge join, or sort join, and so on. The physical plan may be specific to a database system, whereas the logical plan may be independent of database systems and may be executed on any target database system by converting to a physical plan for that target database system.

The code generator 550 generates code representing executable instructions for implementing the physical plan for executing a database query. The generated code includes a set of instructions for each operator specified in the execution plan. The generated code is specified using a programming language that may be compiled and executed.

### Block Diagram for Generating Moving Average Parameters

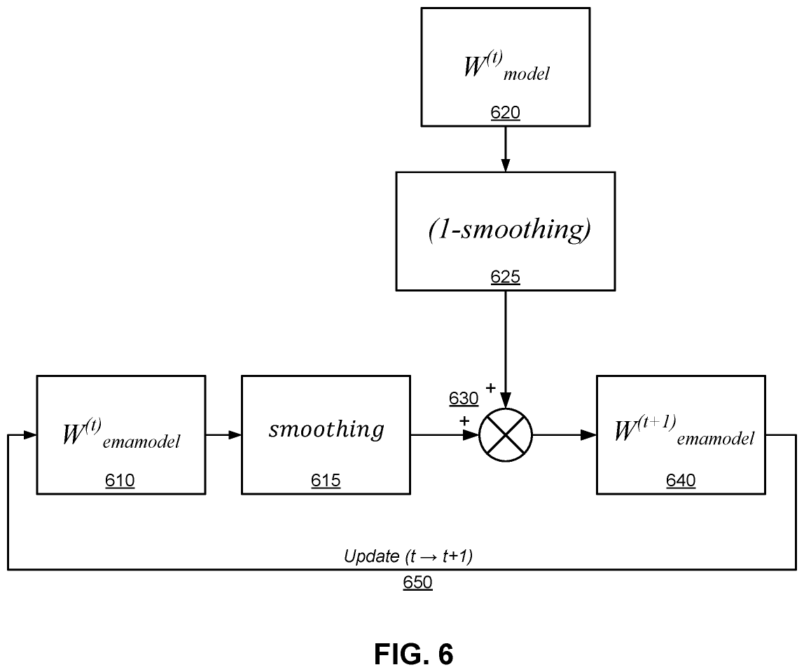

FIG. 6 is a block diagram illustrating a process for generating and updating moving average parameters, in accordance with an embodiment. The moving average parameters of the previous iteration 610, W_{emamodel}^{(t)}, are multiplied by the smoothing constant 615, smoothing. The training parameters of the previous iteration 620, W_{model}^{(t)}, are multiplied by a factor of one minus the smoothing constant 625, (1−smoothing). The two terms are summed at the summing junction 630 to produce the moving average parameters for the current iteration 640, W_{emamodel}^{(t+1)}. The training module 350 updates 650 the moving average parameters for the next iteration as the moving average parameters for the current iteration.

### Transformer Model Training

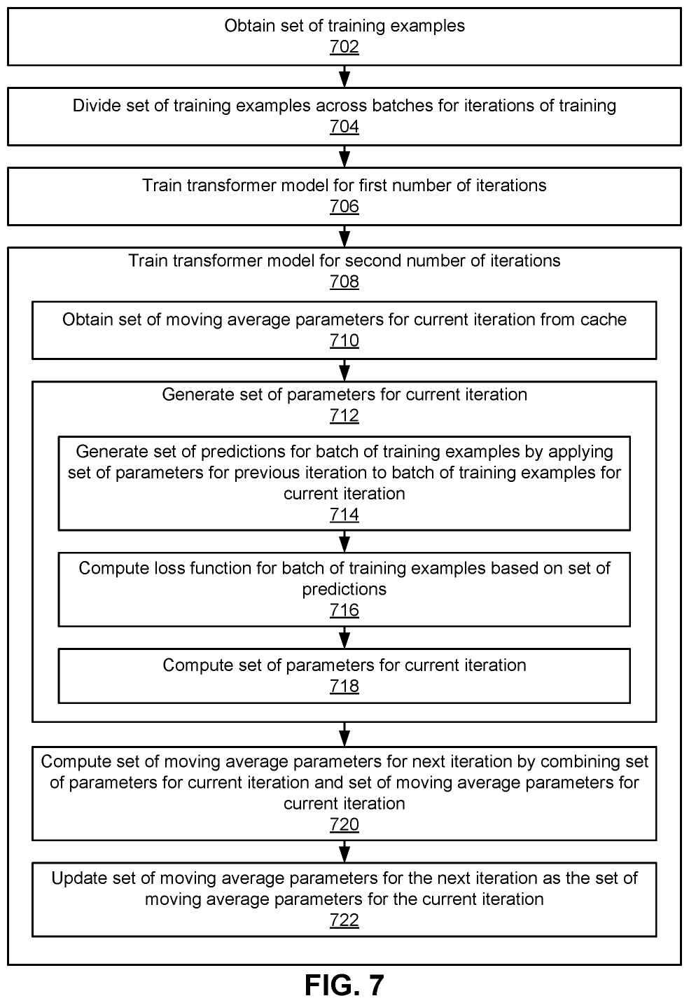

FIG. 7 is a flowchart of a method for training a transformer model, in accordance with an embodiment. The process shown in FIG. 7 may be performed by one or more components (e.g., the control layer 106) of a data processing system/service (e.g., the data processing service 102). Other entities may perform some or all of the steps in FIG. 7. The data processing service 102 as well as the other entities may include some or more of the component of the machine (e.g., computer system) described in conjunction with FIG. 8. Embodiments may include different and/or additional steps, or perform the steps in different orders.

The process begins with the control layer 106 obtaining 702 a set of training examples. The control layer 106 may obtain the training examples from a cache or from the data store 270. The control layer 106 divides 704 the set of training examples across batches for iterations of training.

The control layer 106 trains 706 the transformer model in a first stage for a first number of iterations. For a first number of iterations, the control layer 106 trains the transformer model without calculating a moving average of training parameters. Instead, the control layer 106 generates predictions by applying the training parameters of the previous iteration to the batch of training examples for the current iteration. The training module 350 computes a loss function for the batch of training examples based on the set of predictions and computes training parameters for the current iteration to reduce the loss function.

The control layer 106 trains 708 the transformer model in a second stage for a second number of iterations. To train 708 the transformer model in a second stage, the control layer 106 obtains 710 a set of moving average parameters for a current iteration from a cache. The control layer 106 generates 712 a set of training parameters for the current iteration. In doing so, the control layer 106 generates 714 a set of predictions for a batch of training examples by applying a set of parameters of the transformer model for a previous iteration to the batch of training examples for the current iteration. The control layer 106 computes 716 a loss function for the batch of training examples based on the set of predictions. The control layer 106 computes 718 the set of parameters for the current iteration. The control layer 106 computes the parameters to reduce the loss function.

The control layer 106 computes 720 a set of moving average parameters for a next iteration by combining the set of parameters for the current iteration and the set of moving average parameters for the current iteration. The control layer 106 updates 722 the set of moving average parameters of the transformer model for the next iteration as the set of moving average parameters for the current iteration.

Turning now to FIG. 8, illustrated is an example machine to read and execute computer readable instructions, in accordance with an embodiment. Specifically, FIG. 8 shows a diagrammatic representation of the data processing service 102 (and/or data processing system) in the example form of a computer system 800. The computer system 800 is structured and configured to operate through one or more other systems (or subsystems) as described herein. The computer system 800 can be used to execute instructions 824 (e.g., program code or software) for causing the machine (or some or all of the components thereof) to perform any one or more of the methodologies (or processes) described herein. In executing the instructions, the computer system 800 operates in a specific manner as per the functionality described. The computer system 800 may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The computer system 800 may be a server computer, a client computer, a personal computer (PC), a tablet PC, a smartphone, an internet of things (IoT) appliance, a network router, switch or bridge, or other machine capable of executing instructions 824 (sequential or otherwise) that enable actions as set forth by the instructions 824. Further, while only a single machine is illustrated, the term “machine” shall also be taken to include any collection of machines that individually or jointly execute instructions 824 to perform any one or more of the methodologies discussed herein.

The example computer system 800 includes a processing system 802. The processor system 802 includes one or more processors. The processor system 802 may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of these. The processor system 802 executes an operating system for the computing system 800. The computer system 800 also includes a memory system 804. The memory system 804 may include or more memories (e.g., dynamic random access memory (RAM), static RAM, cache memory). The computer system 800 may include a storage system 816 that includes one or more machine readable storage devices (e.g., magnetic disk drive, optical disk drive, solid state memory disk drive).

The storage unit 816 stores instructions 824 (e.g., software) embodying any one or more of the methodologies or functions described herein. For example, the instructions 824 may include instructions for implementing the functionalities of the transaction module 330 and/or the file management module 335. The instructions 824 may also reside, completely or at least partially, within the memory system 804 or within the processing system 802 (e.g., within a processor cache memory) during execution thereof by the computer system 800, the main memory 804 and the processor system 802 also constituting machine-readable media. The instructions 824 may be transmitted or received over a network 826, such as the network 826, via the network interface device 820.

The storage system 816 should be taken to include a single medium or multiple media (e.g., a centralized or distributed database, or associated caches and servers communicatively coupled through the network interface system 820) able to store the instructions 824. The term “machine-readable medium” shall also be taken to include any medium that is capable of storing instructions 824 for execution by the machine and that cause the machine to perform any one or more of the methodologies disclosed herein. The term “machine-readable medium” includes, but not be limited to, data repositories in the form of solid-state memories, optical media, and magnetic media.

In addition, the computer system 800 can include a display system 810. The display system 810 may driver firmware (or code) to enable rendering on one or more visual devices, e.g., drive a plasma display panel (PDP), a liquid crystal display (LCD), or a projector. The computer system 800 also may include one or more input/output systems 812. The input/output (IO) systems 812 may include input devices (e.g., a keyboard, mouse (or trackpad), a pen (or stylus), microphone) or output devices (e.g., a speaker). The computer system 800 also may include a network interface system 820. The network interface system 820 may include one or more network devices that are configured to communicate with an external network 826. The external network 826 may be a wired (e.g., ethernet) or wireless (e.g., WiFi, BLUETOOTH, near field communication (NFC).

The processor system 802, the memory system 804, the storage system 816, the display system 810, the IO systems 812, and the network interface system 820 are communicatively coupled via a computing bus 808.

### Additional Considerations

The foregoing description of the embodiments of the disclosed subject matter have been presented for the purpose of illustration; it is not intended to be exhaustive or to limit the disclosed embodiments to the precise forms disclosed. Persons skilled in the relevant art can appreciate that many modifications and variations are possible in light of the disclosed subject matter.

Some portions of this description describe various embodiments of the disclosed subject matter in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the disclosed subject matter may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the present disclosure may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the disclosed embodiments be limited not by this detailed description, but rather by any claims that issue on an application based hereon. Accordingly, the disclosure of the embodiments of the disclosed subject matter is intended to be illustrative, but not limiting, of the scope of the subject matter, which is set forth in the following claims.

What is claimed is:

1. A method of training a transformer model, comprising:
obtaining a set of training examples;
dividing the set of training examples across one or more batches for one or more iterations of training parameters of the transformer model;
training the transformer model for a first number of iterations by repeatedly updating parameters of the transformer model;
training the transformer model for a second number of iterations, for each iteration in the second number of iterations:
obtaining a set of moving average parameters for a current iteration from a cache,
generating a set of parameters for the current iteration, comprising:
generating a set of predictions for a batch of training examples by applying a set of parameters of the transformer model for a previous iteration to the batch of training examples for the current iteration,
computing a loss function for the batch of training examples based on the set of predictions,
computing the set of parameters for the current iteration, wherein the set of parameters are computed to reduce the loss function,
computing a set of moving average parameters for a next iteration by combining the set of parameters for the current iteration and the set of moving average parameters for the current iteration, and
updating the set moving average parameters of the transformer model for the next iteration as the set of moving average parameters for the current iteration.

2. The method of claim 1, wherein training the transformer model for the first number of iterations to repeatedly update parameters of the transformer model comprises, for each iteration in the first number of iterations:
generating a set of predictions for a batch of training examples by applying a set of parameters of the transformer model for a previous iteration to the batch of training examples for the current iteration;
computing a loss function for the batch of training examples based on the set of predictions; and
computing the set of parameters for the current iteration, wherein the set of parameters are computed to reduce the loss function.

3. The method of claim 2, wherein training the transformer model for the first number of iterations comprises training the transformer model without computing a moving average of the parameters of the transformer model.

4. The method of claim 1, wherein the transformer model is a stable diffusion model coupled to receive input as text and generate an output as an image.

5. The method of claim 4, wherein the stable diffusion model includes one or more layers configured as a U-net, wherein the computing of the set of moving average parameters for the next iteration excludes a subset of parameters for attention layers of the U-net.

6. The method of claim 1, wherein combining the set of parameters for the current iteration and the set of moving average parameters for the current iteration comprises:
scaling the set of moving average parameters for the current iteration by a smoothing term;
scaling the set of parameters for the current iteration by one minus the smoothing term; and
summing the scaled set of moving average parameters for the current iteration and the scaled set of parameters for the current iteration.

7. The method of claim 1, further comprising determining the first number of iterations based on a total number of iterations and the smoothing term, such that a degree of decay of the parameters of the transformer model computed in the first number of training iterations is less than a predetermined threshold after training the model for the second number of iterations.

8. A non-transitory computer readable storage medium comprising stored program code, the program code comprising instructions, the instructions when executed causes a processor system to:
obtain a set of training examples;
divide the set of training examples across one or more batches for one or more iterations of training parameters of the transformer model;
train the transformer model for a first number of iterations to repeatedly update parameters of the transformer model;
train the transformer model for a second number of iterations, for each iteration in the second number of iterations:
obtaining a set of moving average parameters for a current iteration from a cache,
generating a set of parameters for the current iteration, comprising:
generating a set of predictions for a batch of training examples by applying a set of parameters of the transformer model for a previous iteration to the batch of training examples for the current iteration,
computing a loss function for the batch of training examples based on the set of predictions,
computing the set of parameters for the current iteration, wherein the set of parameters are computed to reduce the loss function,
computing a set of moving average parameters for a next iteration by combining the set of parameters for the current iteration and the set of moving average parameters for the current iteration, and
updating the set moving average parameters of the transformer model for the next iteration as the set of moving average parameters for the current iteration.

9. The non-transitory computer readable storage medium of claim 8, wherein the instructions to train the transformer model for the first number of iterations to repeatedly update parameters of the transformer model comprise instructions that, when executed, cause the processor system to, for each iteration in the first number of iterations:
generate a set of predictions for a batch of training examples by applying a set of parameters of the transformer model for a previous iteration to the batch of training examples for the current iteration;
compute a loss function for the batch of training examples based on the set of predictions; and
compute the set of parameters for the current iteration, wherein the set of parameters are computed to reduce the loss function.

10. The non-transitory computer readable storage medium of claim 9, wherein the instructions to train the transformer model for the first number of iterations comprise instructions that, when executed, cause the processor system to train the transformer model without computing a moving average of the parameters of the transformer model.

11. The non-transitory computer readable storage medium of claim 8, wherein the transformer model is a stable diffusion model coupled to receive input as text and generate an output as an image.

12. The non-transitory computer readable storage medium of claim 11, wherein the stable diffusion model includes one or more layers configured as a U-net, wherein the instructions for computing the set of moving average parameters for the next iteration excludes a subset of parameters for attention layers of the U-net.

13. The non-transitory computer readable storage medium of claim 8, wherein the instructions for combining the set of parameters for the current iteration and the set of moving average parameters for the current iteration comprise instructions that, when executed, cause the processor system to:
scale the set of moving average parameters for the current iteration by a smoothing term;
scale the set of parameters for the current iteration by one minus the smoothing term; and
sum the scaled set of moving average parameters for the current iteration and the scaled set of parameters for the current iteration.

14. The non-transitory computer readable storage medium of claim 8, wherein the instructions further comprise instructions that, when executed, cause the processor system to determine the first number of iterations based on a total number of iterations and a smoothing term, such that a degree of decay of the parameters of the transformer model computed in the first number of training iterations is less than a predetermined threshold after training the model for the second number of iterations.

15. A computer system, comprising:
a computer processor; and
a non-transitory computer readable storage medium comprising stored program code, the program code comprising instructions, the instructions when executed causes a processor system to:
obtain a set of training examples;
divide the set of training examples across one or more batches for one or more iterations of training parameters of the transformer model;
train the transformer model for a first number of iterations to repeatedly update parameters of the transformer model;
train the transformer model for a second number of iterations, for each iteration in the second number of iterations:
obtaining a set of moving average parameters for a current iteration from a cache,
generating a set of parameters for the current iteration, comprising:
generating a set of predictions for a batch of training examples by applying a set of parameters of the transformer model for a previous iteration to the batch of training examples for the current iteration,
computing a loss function for the batch of training examples based on the set of predictions,
computing the set of parameters for the current iteration, wherein the set of parameters are computed to reduce the loss function,
computing a set of moving average parameters for a next iteration by combining the set of parameters for the current iteration and the set of moving average parameters for the current iteration, and
updating the set moving average parameters of the transformer model for the next iteration as the set of moving average parameters for the current iteration.

16. The computer system of claim 15, wherein the instructions to train the transformer model for the first number of iterations to repeatedly update parameters of the transformer model comprise instructions that, when executed, cause the processor system to, for each iteration in the first number of iterations:
generate a set of predictions for a batch of training examples by applying a set of parameters of the transformer model for a previous iteration to the batch of training examples for the current iteration;
compute a loss function for the batch of training examples based on the set of predictions; and
compute the set of parameters for the current iteration, wherein the set of parameters are computed to reduce the loss function.

17. The computer system of claim 16, wherein the instructions to train the transformer model for the first number of iterations comprise instructions that, when executed, cause the processor system to train the transformer model without computing a moving average of the parameters of the transformer model.

18. The computer system of claim 15, wherein the transformer model is a stable diffusion model coupled to receive input as text and generate an output as an image.

19. The computer system of claim 18, wherein the stable diffusion model includes one or more layers configured as a U-net, wherein the instructions for computing the set of moving average parameters for the next iteration excludes a subset of parameters for attention layers of the U-net.

20. The computer system of claim 15, wherein the instructions to combine the set of parameters for the current iteration and the set of moving average parameters for the current iteration comprise instructions that, when executed, cause the processor system to:
scale the set of moving average parameters for the current iteration by a smoothing term;
scale the set of parameters for the current iteration by one minus the smoothing term; and
sum the scaled set of moving average parameters for the current iteration and the scaled set of parameters for the current iteration.
